(19) United States
(12) Patent Application Publication
(10) Pub. No.: US 2002/0145766 A1
(43) Pub. Date: Oct. 10, 2002

(54) Method for controlling scanner

(75) Inventors: Shiang-Yau Liang, Tainan (TW); Chang-Tang Su, Hsinchu (TW); Mu-Teng Chung, Yuanli Jen (TW); Chi-Jung Hung, Lugang Jen (TW)

Correspondence Address: LOWE HAUPTMAN GOPSTEIN GILMAN & BERNER, LLP, Suite 310, 1700 Diagonal Road, Alexandria, VA, 22314, US

(73) Assignee: MUSTEK SYSTEMS INC.

(21) Appl. No.: 09/825,849

(22) Filed: Apr. 5, 2001

(51) Int. Cl. H04N 1/04

(52) U.S. Cl. 358/474

(57) ABSTRACT

The present invention relates to a full-auto scan control method and without central processing unit (CPU) of computer operation. There are two groups of register pre-reserved inside the system according to the original design. The control parameter can be installed before scan is operation. The system is able to read responded parameter when it inquires. Therefore there is no requirement of the CPU of computer control it when it is under scanning situation. The scan operation is controlled by pre-reserved control parameter data, which is installed into scanner via applied specific integrated circuit (ASIC) of scanner. And also it is recycled into the end of scan process. The best feature is no wasting time and without using computer according to the present invention.

### BACKGROUND OF THE INVENTION

1. The Field of Invention

The present invention relates to a method for controlling scanner, more particularly it is a control method of full-auto scan mode that is no requirement of central processing unit (CPU) of computer operation.

2. Description of the Prior Art

The development of computer carries out a new generation of human life at this 20^{th} century, also improves human life much better than before. The computer can also provide many functions such as saving data, transferring message, computing and so on. In the computer world, everything will be recorded via electrical-type files. All the written paper also are transferred and saved as electrical-type files for the operation of computer. Therefore using scanner is the most convenient method for saving and transferring useful message. Especially the scanner is the most useful technique for converting optical signal into electrical signal, such as computer media.

Therefore, according to the above statement, there are at least three functions provided from the scanner. Firstly, scanner will own a function of optical sensor for sensitizing object. Secondly it needs a loading system with the optical sensor portion for moving and scanning all objects. Thirdly there is a function for recording in real time and transferring data. The previous data can be finally transferred to personal computer (PC). Thus, for achieving the above function, there should be setup the optical scan system including light source, lens, reflective lens and CCD. Also the loading system will include motor, roller and belt. For memorizing and transferring data, the system concludes some elements such as memory, data transmission line and bus.

Thus “control” according to the different condition should be the key to all the assembly of scanner. For example, controlling exposure time, sensitizing red-green-blue (RGB) color, reading data, controlling motor-speed can decide how to increase speed, how to keep uniform speed of motor and reduce speed of motor.

FIG. 1 is the control system of prior art, wherein the system is designed for controlling scanner by the operation of PC. The program 111 can be setup for the color parameter in selecting and scanning. The program 112 is to decide sensitizing RGB color and read it, so that color data will be obtained.

Program 113 to 117 is the process for transferring data in control process. Also, in case memory is full, the process is still kept operation. Such as program 113, the function is for checking memory as well as it is for data transformation and motor operation (program 114). Sequentially it will wait for the treatment of computer. The program 115 will check whether memory is free for saving data, then to decide whether it will be back for scanning again, if memory is free (program 116).

Program 118 and 119 is for controlling the operation of motor. The resolution is decided by controlling motor-speed in the process. The time of the scanning area of optical sensor will be short if motor-speed is higher. Therefore the resolution of picture is lower. On the other hand, while the resolution is higher and it will take longer time. Furthermore, the speed of motor operation can be gradually increased, it also can keep all loading system with optical sensor stable. The speed is gradually reduced when the process is going to finish. Then all loading system will move back to the original position. In program 118, its function can check motor situation and decide whether the speed or situation of motor is changed. The program 119 will be executed if the condition or situation is required to be changed.

Program 120 and 121 is for deciding whether all scan should be continuously processed. Program 120 is for checking continuously all scan process and program 121 will decide whether whole process can stop. Therefore the prior art using 111 to 121 is for controlling optical sensor, loading system, saving and transferring data in order to complete all scan process.

However, according to the prior art, CPU will poll the ASIC of scanner and obtain information. Then CPU can change scan situation via instruction. Thus, the software is designed to drive CPU polling ASIC and it will reduce the efficiency of CPU, also increase scanning time and make design of software difficult.

### SUMMARY OF INVENTION

The present invention provides a control method of full-auto mode and it can be controlled without CPU operation of computer. The main concept of this invention is that all kinds of control parameter of scan situation pre-loaded into the system for ASIC's use. As previous mentioned, the CPU of computer need to poll ASIC in real time and change control parameter of system in order to responsed any sort of situation of scan operation. On the other word, the setup for all suitable control parameter will depend on the different kind of situation. Unfortunately the complex processes can seriously reduce efficiency of scanner. If all the possible situation can be listed in advance and all responded control parameter can be setup as a control table, also loaded into the system, while situation happens, all sorts of accident will be handled. Thus, the setup parameter of control table is preserved inside the ASIC of scanner and it can control the operation of scan. The setup parameter of control table also will be recycled until end scan process ended.

Therefore, this invention is setup by the following parameter in order to preserve two groups of register inside the system.

For the first register:

1. C: Channel, shows scanning color;

2. M: Motor, shows motor operation;

3. C: Check buffer, shows checking the situation of register.

For the second register:

1. The control setup for increasing motor-speed;

2. The uniform motor-speed in scanning;

3. The control setup for reducing motor-speed.

Through the above control parameter table, it is easy to control optical sensor, loading system, saving and transferring data by using the ASIC of scanner, this can achieve a control method of full-auto scan mode. Not only there is no requirement of CPU operation for this invention, but also it will increase efficiency of scanning process.

### BRIEF DESCRIPTION OF THE DRAWINGS

Further details of the present invention will be apparent to those skilled in the art by reference to the exemplary embodiment in the drawings in which:

FIG. 1 shows the scanning control system of prior art;

FIG. 2 illustrates the CMC data table of this embodiment;

FIG. 3 indicates Motor-speed data table of this embodiment; and

FIG. 4 illustrates the scanning path of this embodiment.

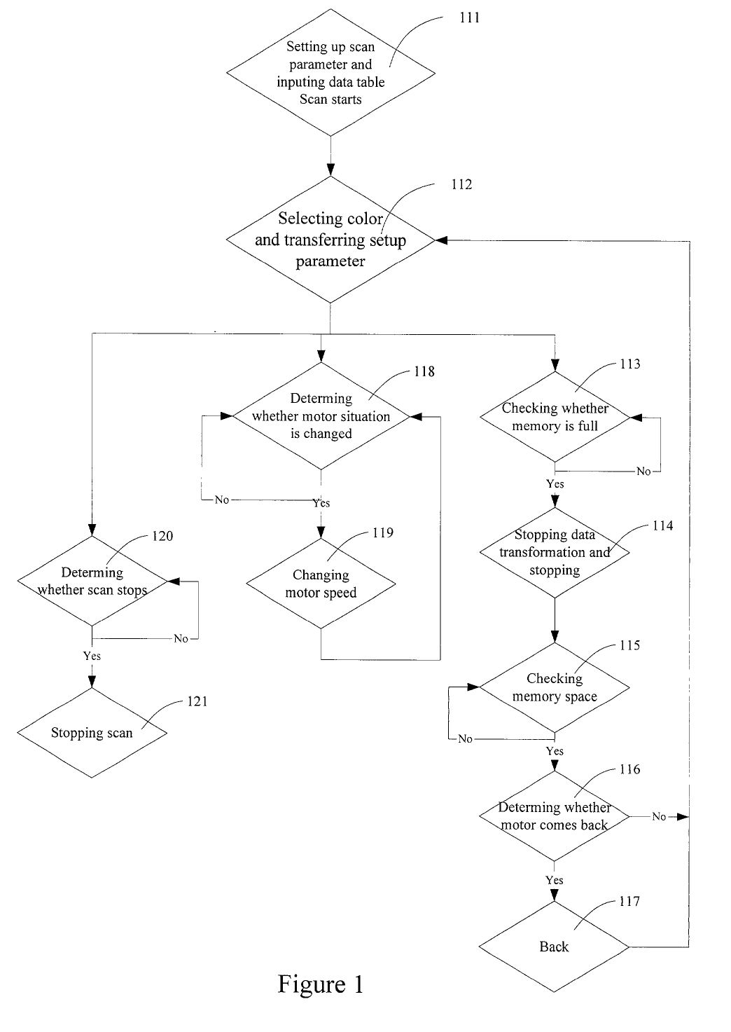

### DESCRIPTION OF THE PREFERRED EMBODIMENT

The following is a description of the present invention. The invention will firstly be described with reference to one exemplary structure. Some variations will then be described as well as advantages of the present invention. A preferred method of fabrication will then be discussed. An alternate, asymmetric embodiment will then be described along with the variations in the process flow to fabricate this embodiment.

According to the previous statement, through the above control parameter table, it is easy to control optical sensor, loading system, saving and transferring data by using ASIC of scanner, this can achieve a control method of full-auto scan mode. Before scan process starts, there are two groups of register preserved inside the system.

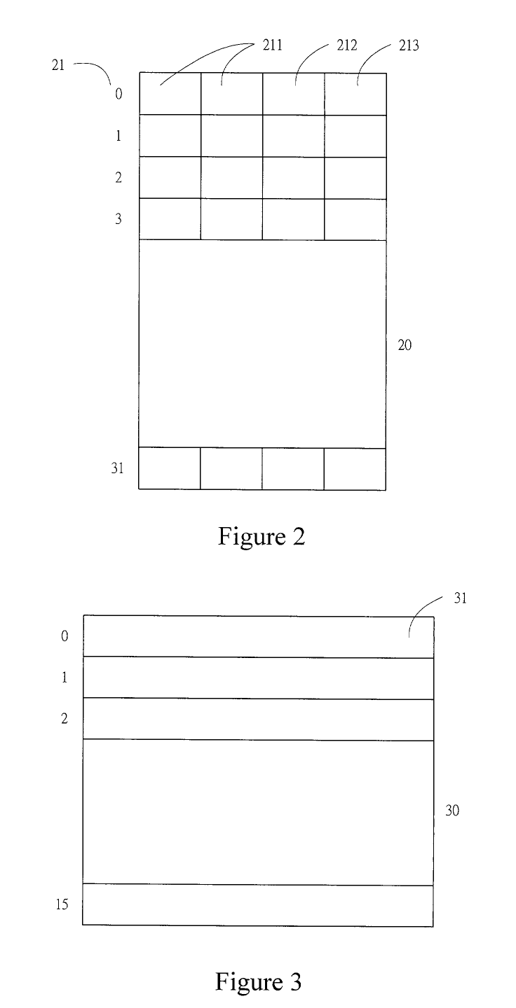

FIG. 2 shows the first register, which is called as CMC table. The main body of CMC table is a 32×4 bit registers 20, which concludes thirty-two 4-bit memory cells 21. These 4-bit memory cells can record the following parameter:

Channel bit: color control bit 211;

“00” shows not sensitizing;

“01” shows sensitizing and reading red-light data;

“10” shows sensitizing and reading green-light data;

“11” shows sensitizing and reading blue-light data.

Motor bit: Motor bit 212

“0”: stepper-motor stops

“1”: stepper-motor will run in responded speed and match with the value of motor-speed table after the next touching signal.

Check buffer: memory checking bit 213

“0” shows not checking whether register being full;

“1” illustrates checking whether register being full. The whole CMC table will be stopped until register can be use.

FIG. 3 shows a second register, which is called as motor-speed table. The main part of motor-speed table is a 16×8 bit registers 30, which concludes sixteen 8 bit memory cells 31. This 8-bit memory cell can control the speed of stepper-motor. Therefore, reading motor-speed table can control the speed of motor.

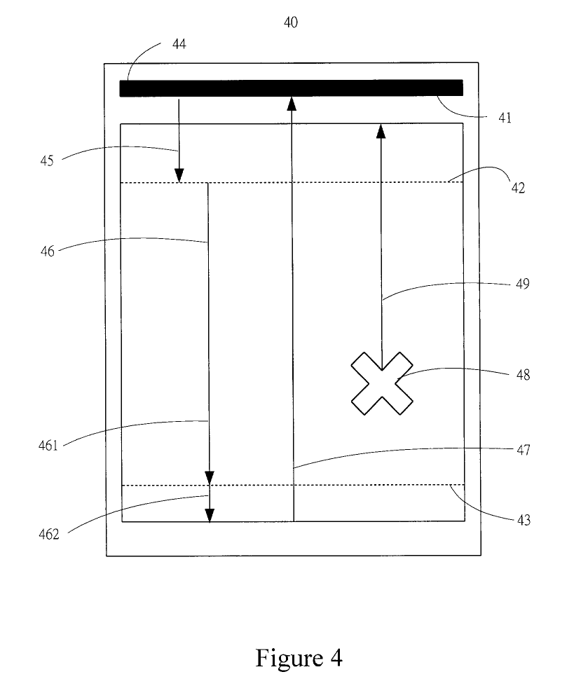

FIG. 4 illustrates a scanning path. There is loading system 44 upon scanner 40, which concludes an optical sensor. Loading system 44 can be moved using motor and then the optical sensor can start scanning. The whole scanning process is the following:

Firstly as FIG. 4, scan area, resolution, and the depth of exposure and so on will be input into computer. Computer can decide original position 41, starting position 42, and ending position 43 according to the previous setup of users. The whole data including exposure time, starting condition, ending condition, whether memory being full-load and so on will be installed into the setting table, then the proper CMC table and motor-speed table will be installed into the preserved register of scanner.

Table 1 and Table 2 show respectively CMC table and motor-speed table. C0 shows the number zero data of CMC table, M5 shows the number five of motor-speed table for the following description.

When scan process starts, loading system will move along with first path 45, from original position 41 to starting scan position 42 in the increment-speed. At this path, due to only the loading system is removed and without scan operation, the C0 of CMC table will be selected.

The data of C0 is (00, 1, 0), it shows all system situation is controlled under without optical sensitizing and under driving motor as well as not checking register. At this increment-speed path, the motor control will be depended on motor-speed according to M0, M1, M2, M3 until to M4. (Meanwhile it arrives starting position 42, therefore M4 is also called as scanning-speed).

After it arrives starting position 42, loading system 44 will move along with second path 46. The distance between the starting position 42 to ending position 43 is the uniform-speed section of second path 461. Then scan process operates. The scan speed for controlling motor is under M4. The control data of optical sensor is started from C1 sensitizing red light, then selecting C2, C3 in sequence. Sequentially C4 will move to next position and repeat the above cycle. It will check continuously whether register is full in the optical sensor recycles process. The full memory presents data that is not removed in real time, therefore sensor operation will be stopped.

While loading system 44 moves to ending position 43, scan process will be ended. Therefore controlling data will be selected as C0, the motor-speed will be as M4 to M3, M2 and M1, respectively and stopped at M0. The path will be called as the reduced speed section of second path 462. Then, along with third path 47, it is back to the original position. The control data will be C0, motor control data reversibly increased speed from M5 to M8, then gradually reduced to M0. Finally the whole process is completely.

If the error event 48 happens such as register being full in scan process, the CMC table will stop via C5. When register gets ready, it will drive loading system to go back to original position 41 along with the fourth path 49.

Table 3 is the selected control data in operation for every path.

CMC table and motor-speed table for loading data will be used by conventional logical circuit method while circuit is designed. Especially the data can be written using decoder matched with the circuit of register. For reading, the timing impulse can be connected with the input of adder. The output of adder will be changed.

The input end of adder can be connected to the reading line of register and the requirement data can be picked up in sequence. The cycle is such as C1>C2>C3>C4>C1.

First of all, the C1 address will be setup in the adder. Then the first input end of comparer is input the C4 address. It will be the compared value. Then the above output of adder is connected to the second input end of this comparer. Finally the output of comparer can be equal to the estimated output of adder. When the output value increased from C1 to C4, the output of comparer can be 1, in order to drive an estimated value of adder that is 1. Thus it can achieve a recycled goal according to this present invention.

What is claimed is:

1. A method for controlling scanner, wherein said method controlling a scan process thereby said method listing all scan conditions and listing all responded control parameters of said scan conditions as parameter table so that said parameter table loading inside said scanner for scan calling herein.

2. The method according to claim 1, wherein said control parameter comprises:
setting color;
driving a motor; and
checking a register.

3. The method according to claim 2, wherein said setting color comprises:
setting said scanner as not sensitizing;
setting said scanner as reading red-light data;
setting said scanner as reading green-light data; and
setting said scanner as reading blue-light data.

4. The method according to claim 1, wherein said control parameter comprises:
a control setup for increasing motor-speed;
an uniform motor speed in scan process; and
a control setup for reducing motor-speed.

5. An operation method for controlling scanner, wherein said method comprises:
pre-reserving a memory space inside scanner;
setting scan parameter;
loading control data; and
starting scan.

6. The method according to claim 5, wherein said operation method comprises two groups of register that providing a reserved memory space inside said scanner.

7. The method according to claim 5, wherein said setting scan parameter comprises
a resolution parameter;
an exposure parameter; and
an original position, a starting position and an ending position.

8. The method according to claim 5, wherein said control data comprises:
setting color;
driving motor; and
checking register.

9. The method according to claim 8, wherein said setting color comprises:
setting said scanner as not sensitizing;
setting said scanner as reading red-light data;
setting said scanner as reading green-light data; and
setting said scanner as reading blue-light data.

10. The method according to claim 5, wherein said control data comprises;
a control setup for increasing motor-speed;
an uniform motor speed in scan process; and
a control setup for reducing motor-speed.

11. A method for scanner operation, said scanner comprising a loading system having a optical scanner therefrom said method comprises:
setting scan parameter, therein said parameter comprising:
an original position;
a scan position; and
an ending position;
loading a first control table having color setting and driving motor and checking register;
loading a second control table having a setup for increasing motor-speed and for an uniform motor speed in scan process and for reducing motor-speed.
calling said first control table and said second table so that loading system moving;
calling said first control table and said second table so that said optical sensor and said loading system moving in uniform-speed from said original position to said ending position;
calling said first control table and said second table so that said loading system returning back to said original position and completing a scan operation process.

12. The method according to claim 11, wherein said first control table comprises:
not checking optical sensor;
driving motor; and
not checking register.

13. The method according to claim 11, wherein said calling first control table method comprises:
sensitizing red-light data and not checking motor and checking register;
sensitizing green-light data and not checking motor and checking register;
sensitizing blue-light data and not checking motor and checking register; and
not sensitizing data and driving motor and not checking register.

14. The method according to claim 11, wherein said calling first control table method comprises:
not optical sensitizing and not driving motor and not checking register; and
not optical sensitizing and driving motor and not checking register.
